(19) United States
(12) Patent Application Publication
(10) Pub. No.: US 2012/0067190 A1
(43) Pub. Date: Mar. 22, 2012

(54) BEVELED-EDGE MAKER

(76) Inventors: Cheng-Hui Tseng, Taichung (TW); Kun-Meng Lin, Changhua County (TW)

(21) Appl. No.: 12/884,224

(22) Filed: Sep. 17, 2010

(51) Int. Cl. B26D 3/02; B26D 7/00

(52) U.S. Cl. 83/869; 83/743; 83/581

(57) ABSTRACT

A beveled-edge maker (1) for chamfering a workpiece (2), the tool comprising a knife assembly (4) adapted for attaching to a drive (5), and at least one guider (8) adapted such that the beveled-edge maker can be mounted to the edge of the workpiece and moved there along.

### TECHNICAL FIELD

A tool for chamfering is disclosed, and particularly, although not exclusively, a tool for chamfering the edges of tubes and sheets.

### BACKGROUND ART

Recent improvements in construction materials and techniques have given rise to the widespread use of plastic piping and plastic sheets. Plastic piping has proven especially useful as a conduit for the protection of underground electrical wiring and as drainpipe for use in plumbing.

In many applications, such tube is formed in predetermined lengths and placed end-to-end and a connector is placed over the ends to join the tubes together. Alternatively, two or more tubes may be joined together by means of widening or belling the end or using rubber ring joints on one tube and chamfering the end of another tube. Hence chamfering the ends of tubes can be used to allow one tube to be inserted into another or to allow a tube to be inserted into a connector.

Further, if desired, a tube end may be provided with an internal chamfer. if the tube is to be used as protection for electrical cable, the internal surface of the tube may be chamfered to prevent there being sharp edges that may allow the cable insulation to be frayed, torn or broken as it is being threaded through the tube.

Tubes composed of alternate materials such as metal or concrete may also require chamfering.

Previous beveled-edge makers generally comprise a holder and a knife assembly angularly offset to the holder.

### SUMMARY OF THE DISCLOSURE

A beveled-edge maker for chamfering a workpiece, the tool comprising a knife assembly adapted for attaching to a drive, and at least one guider adapted such that the beveled-edge maker can be mounted to the edge of the workpiece and moved there along.

In one form the knife assembly is rotatable.

In one form the knife assembly is adapted for attaching with a drill.

In one form the knife assembly comprises a plurality of blades positioned to form an inverted cone shape.

In one form each guider comprises at least one, and typically three, downwardly extending revolvers, each downwardly extending revolver having a rolling member attached thereto.

In one form the rolling member comprises a cylindrical roller adapted in use to be in rolling contact with the workpiece.

In one form the three guiders are positioned such that in use one guider is positioned on one side of the workpiece adjacent to the edge and the other guider is positioned on the other side of the workpiece adjacent to the edge.

In one form the workpiece is a tube and the sides correspond to inside and outside surfaces of the tube.

In one form the or each guider is movable in relation to the knife assembly. In one form each guider is movable in relation to any other guider.

In one form the beveled-edge maker further comprises a disk to which the knife assembly and the or each guider is attached.

### BRIEF DESCRIPTION OF THE DRAWINGS

It is convenient to hereinafter describe an embodiment of a beveled-edge maker with reference to the accompanying drawings. It is to be appreciated that the particularity of the drawings and the related descriptions is to be understood as not superseding the generality of the preceding broad description of the beveled-edge maker.

In the drawings:

FIG. 1 is a top perspective view of a beveled-edge maker and tube;

FIG. 2 is a side perspective view of a beveled-edge maker;

FIG. 3 is a front elevation view of the beveled-edge maker of FIG. 2; and

FIG. 4 is a side elevation view of the beveled-edge maker of FIG. 2.

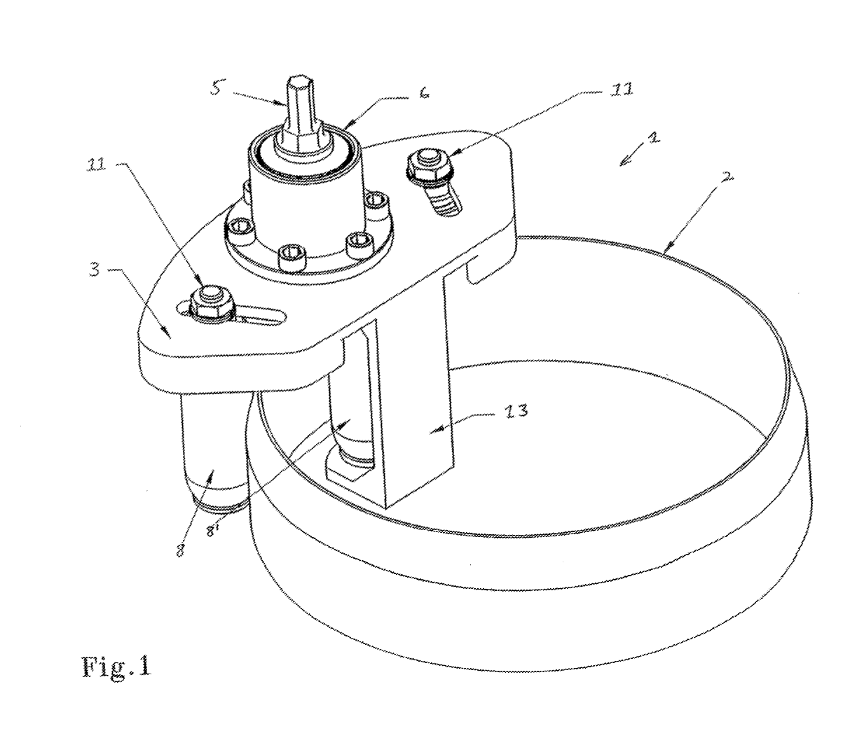

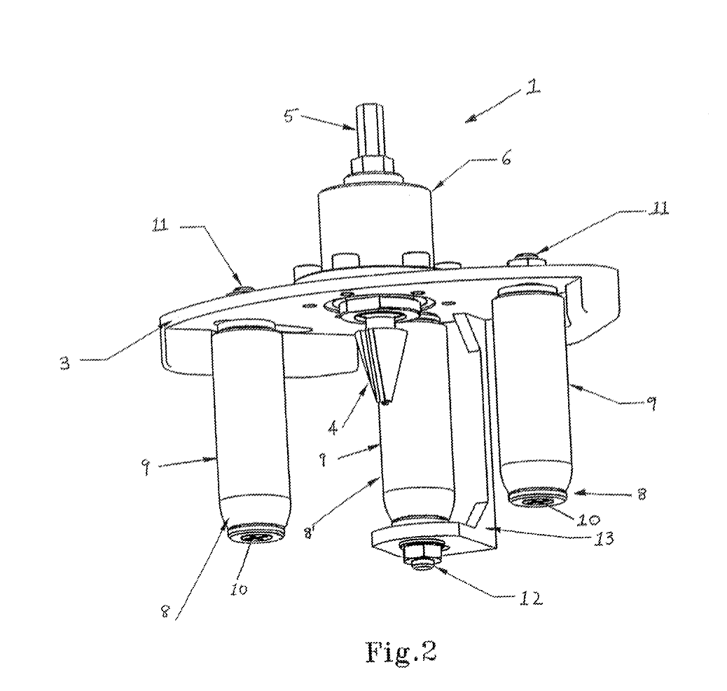

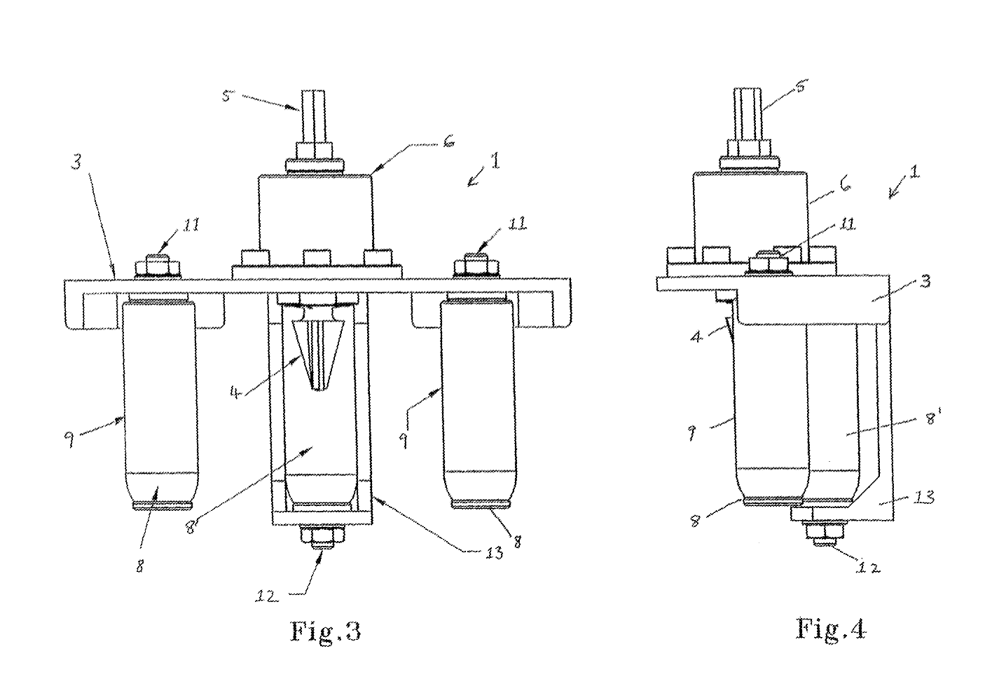

### DETAILED DESCRIPTION OF SPECIFIC EMBODIMENTS

Referring to the figures, disclosed is a beveled-edge maker 1 for chamfering the edges of a tube 2 or other chamferable workpiece.

The beveled-edge maker 1 comprises a knife assembly 4 and transmission rod 5 extending through a disk 3. The knife assembly 4 and transmission rod 5 are attached to the disk 3 by means of a gear kit 6. The knife assembly 4 and transmission rod 5 are attached to one another and are rotatable. When the knife assembly 4 is brought into contact with the edges of a tube or sheet, the rotation of the knife assembly 4 allows the knife assembly 4 to chamfer the edges of the tube or sheet.

The knife assembly 4 is shaped as an inverted cone. In one form the knife assembly 4 comprises a plurality of blades (not illustrated) positioned to form an inverted cone. Typically the knife assembly 4 comprises between two and tell blades and more typically the knife assembly comprises six blades positioned to form an inverted cone.

The knife assembly 4 is replaceable so as to provide varying angles of chamfering. A shorter inverted cone will allow for a shallower angle of chamfering while a longer inverted cone will result in a steeper angle of chamfering. The knife assembly 4 is preset at an angle appropriate for chamfering. In one embodiment this angle is between 12° and 15°.

The transmission rod 5 is adapted to allow attachment of the beveled-edge maker 1 to a drill or other motor (not illustrated). The drill or other motor can be attached with the transmission rod 5 to rotate the knife assembly 4. The transmission rod 5 extends through the gear kit 6 which is attached to the disk 3. it can be seen that this allows a user to utilise the beveled-edge maker with ordinary tools commonly held.

Three guiders 8 are attached with the disk 3. The guiders 8 comprise a rolling member 9 and a revolver 10. The revolver 10 extends through the disk 3 and the rolling member 9 such that the guider 8 is attached with the disk 3. The rolling member 9 comprises a cylindrical roller adapted such that in use the cylindrical roller is in rolling contact with the workpiece to be chamfered.

The guiders 8 are positioned such that in use on a tube 2 one central guider 8′ is positioned inside the tube 2 and two guiders 8 are positioned outside the tube 2. This allows the beveled-edge maker 1 to be mounted on the tube 2 and rolled there around.

The guiders 8 are movable in relation to one another by a first controller 11. The first controller 11 can comprise a screw or a handle which allows the guiders 8 to be moved in relation to each other.

As the tube 2 is inserted between the guiders 8 for chamfering, the first controller 11 allow for the beveled-edge maker 1 to be mounted upon tubes of varying diameters.

The central guider 8′ is also adjustable in relation to the knife assembly 4 by a second controller 12. This allows for varying thickness of the wall of tube 2 or thickness of plastic sheet. The second controller 12 comprises either a screw or a handle or any other appropriate adjustment means.

A frame 13 extends from the disk 3 and supports the central guider 8′. This allows for greater stability of the beveled-edge maker 1.

In use, the guiders 8 are adjusted to best contain the diameter of the tube 2. The central guider 8′ is adjusted to allow for the thickness of the tube 2. The guiders 8 are adjusted by means of loosening the first and second controllers 11 and 12 and moving the guiders 8 to the required position. The first and second controllers 11 and 12 can then be tightened to maintain the guiders 8 in position in relation to one another and in relation to the knife assembly 4. The beveled-edge maker 1 can then be mounted upon the tube 2.

The transmission rod 5 can then be attached to a drill or other motor (not illustrated). When the beveled-edge maker 1 is positioned over the tube 2 the knife assembly 4 is in position to chamfer the edges of the tube 2. When the drill or motor is turned on the knife assembly 4 rotates to chamfer the edges of the tube 2. The beveled-edge maker 1 can then be moved circumferentially about the tube 2. In doing this, the rolling members 9 of the guiders 8 are in rolling contact with the tube allowing for movement of the guiders 8 about the tube 2.

The knife assembly 4 can be positioned inside or outside the tube so as to allow for an internal or external chamfer.

In the claims which follow and in the preceding summary of the invention, except where the context requires otherwise due to express language or necessary implication, the word “comprising” is used in the sense of “including”, that is the features specified may be associated with further features in various embodiments of the invention.

Variations and/or modifications may be made to the parts previously defined without departing from the broad spirit or ambit of the beveled-edge maker.

1. A beveled-edge maker for chamfering a workpiece, the tool comprising:
a knife assembly adapted to be attached to a drive;
at least one guider adapted such that the beveled-edge maker can be mounted to the edge of the workpiece and moved there along.

2. A beveled-edge maker as defined in claim 1, wherein the knife assembly is rotatable.

3. A beveled-edge maker as defined in claim 1 or 2, wherein the drive shaft is adapted to be fitted with a drill.

4. A beveled-edge maker as defined in any of the preceding claims, wherein the knife assembly comprises a plurality of blades positioned to form an inverted cone shape.

5. A beveled-edge maker as defined in claim 4, wherein the knife assembly comprises between two and ten blades.

6. A beveled-edge maker as defined in claim 4 or 5, wherein the inverted cone of the knife assembly has an apex half-angle of between approximately 12° and approximately 15°.

7. A beveled-edge maker as defined in any of the preceding claims wherein the knife assembly is removable.

8. A beveled-edge maker as defined in any of the preceding claims, wherein the or each guider comprises at least one downwardly extending revolver, each downwardly extending revolver having a rolling member attached thereto.

9. A beveled-edge maker as defined in any of the preceding claims wherein the at least one guider comprises three guiders positioned such that in use one guider is positioned on one side of the workpiece adjacent to the edge and the other guider is positioned on the other side of the workpiece adjacent to the edge.

10. A beveled-edge maker as defined in claim 9 wherein the workpiece is a tube and the sides correspond to inside and outside surfaces of the tube.

11. A beveled-edge maker as defined in claims 8-10, wherein the or each rolling member comprises a cylindrical roller adapted in use to be in rolling contact with the workpiece.

12. A beveled-edge maker as defined in any of the preceding claims wherein the or each guider is movable in relation to the knife assembly.

13. A beveled-edge maker as defined in any of the preceding claims wherein each guider is movable in relation to any other guider.

14. A beveled-edge maker as defined in any of the preceding claims further comprising a disk to which the knife assembly and the or each guider is attached.
